(19) United States
(12) Patent Application Publication
(10) Pub. No.: US 2016/0161097 A1
(43) Pub. Date: Jun. 9, 2016

(54) OUTDOOR LIGHTING FIXTURE AND GROUND INSERT THEREOF

(71) Applicant: DONGGUAN YINGHUI LIGHTING CO., LTD., Dongguan (CN)

(72) Inventor: Shuisheng XU, Dongguan (CN)

(21) Appl. No.: 14/957,728

(22) Filed: Dec. 3, 2015

(30) Foreign Application Priority Data
Dec. 8, 2014 (CN) 201410748387.9

(51) Int. Cl. F21V 21/08

(52) U.S. Cl. CPC F21V 21/0824

(57) ABSTRACT

An outdoor lighting fixture comprises a ground insert and a lamp body mounted on the ground insert. The ground insert includes an embedded member and a tread member connected with the top of the embedded member. The embedded member includes a base, a plurality of side plates radially extended downwards and outwards from a bottom surface of the base, and a mounting portion extended upwards from a top surface of the base. The lamp body is mounted on the mounting portion. The tread member is connected with the base. The present invention further provides a ground insert. In the outdoor lighting fixture and the ground insert thereof, provided by the present invention, the tread member connected with the top of the embedded member is adopted so that hands and feet of a user can apply force at the same time.

### FIELD OF THE INVENTION

The present invention relates to a lighting device, in particular to an outdoor lighting fixture and a ground insert thereof.

### BACKGROUND OF THE INVENTION

Outdoor lighting fixtures in the prior art, particularly landscape lamps mounted on the ground, tend to be fixed in the soil by ground inserts. The traditional ground insert tends to be pressed down by hands or tools; or a hole is dug on the ground at first and hence the ground insert is embedded. However, in the case of pressing by hands, the force is often not enough, and hence the ground insert cannot be successfully inserted. Moreover, shovels and other tools are needed to help digging the hole on the ground and the hole must be filled with soil when the ground insert is inserted after digging. Thus, the process is very troublesome.

### SUMMARY OF THE INVENTION

Therefore, the objective of the present invention is to provide an outdoor lighting fixture which has a simple structure and is fast to mount.

The present invention relates to an outdoor lighting fixture, which comprises a ground insert and a lamp body mounted on the ground insert, wherein the ground insert includes an embedded member and a tread member connected with the top of the embedded member; the embedded member includes a base, a plurality of side plates radially extended downwards and outwards from a bottom surface of the base, and a mounting portion extended upwards from a top surface of the base; the lamp body is mounted on the mounting portion; and the tread member is connected with the base.

Moreover, the tread member and the embedded member are integrally formed; the tread member includes a platform portion, a sloping plate for connecting the platform portion and the base of the embedded member, and a riser for connecting the platform portion and the side plate of the embedded member.

Moreover, as the platform portion is higher than the base, the sloping plate is inclined upwards from the base and extended towards the platform portion; and the riser and one side plate are aligned in the same plane and integrally connected.

Moreover, the tread member and the embedded member are separately manufactured; the tread member is formed by the integral bending of a metal rod body; at least two insertion holes are formed on the base of the embedded member; and the tread member is partially embedded into the insertion holes so as to be connected with the embedded member.

Moreover, the base includes two connecting portions; the insertion holes are transversely formed in corresponding connecting portions; the tread member includes a U-shaped body portion, sloping portions respectively connected with two free ends of the body portion, and embedded portions correspondingly connected with free ends of the sloping portions; and the embedded portions are correspondingly inserted into the insertion holes of the connecting portions.

Moreover, the insertion holes are formed on the base by running through up and down; the tread member includes a U-shaped body portion, horizontal portions respectively connected with two free ends of the body portion, and embedded portions correspondingly connected with free ends of the horizontal portions; and the embedded portions are correspondingly vertically inserted into the insertion holes of the connecting portions.

Moreover, the tread member and the embedded member are separately manufactured; the tread member is in the shape of a flat plate and includes a platform portion and limiting portions bent downwards at first and hence bent inwards from two opposite sides of the platform portion; and the platform portion and the limiting portions on both sides are encircled into a flat accommodating space to accommodate the base of the embedded member.

The present invention relates to a ground insert configured to fix a lamp body of an outdoor lamp, wherein the ground insert includes an embedded member and a tread member connected with the top of the embedded member; the embedded member includes a base, a plurality of side plates extended from a bottom surface of the base, and a mounting portion extended upwards from a top surface of the base; the tread member and the embedded member are integrally formed; the tread member includes a platform portion, a sloping plate for connecting the platform portion and the base of the embedded member, and a riser for connecting the platform portion and the side plate of the embedded member; and the riser and one side plate are aligned in the same plane and integrally connected.

The present invention relates to a ground insert configured to fix a lamp body of an outdoor lamp, wherein the ground insert includes an embedded member and a tread member connected with the top of the embedded member; the embedded member includes a base, a plurality of side plates extended from a bottom surface of the base, and a mounting portion extended upwards from a top surface of the base; the tread member and the embedded member are separately manufactured; the tread member is formed by the integral bending of a metal rod body; at least two insertion holes are formed on the base of the embedded member; and the tread member is partially embedded into the insertion holes so as to be connected with the embedded member.

The present invention relates to a ground insert configured to fix a lamp body of an outdoor lamp, wherein the ground insert includes an embedded member and a tread member connected with the top of the embedded member; the embedded member includes a base, a plurality of side plates extended from a bottom surface of the base, and a mounting portion extended upwards from a top surface of the base; the tread member and the embedded member are separately manufactured; the tread member is in the shape of a flat plate and includes a platform portion and limiting portions bent downwards at first and hence bent inwards from two opposite sides of the platform portion; and the platform portion and the limiting portions on both sides are encircled into a flat accommodating space so as to accommodate the base of the embedded member.

Compared with the prior art, in the outdoor lighting fixture and the ground insert thereof, provided by the present invention, the tread member connected with the top of the embedded member is adopted so that hands and feet of a user can apply force at the same time, and hence the entire outdoor lighting fixture can be driven to be inserted into the ground, which is convenient and swift.

### BRIEF DESCRIPTION OF THE DRAWINGS

FIG. 1 is an exploded view of an outdoor lighting fixture provided by the first embodiment of the present invention;

FIG. 2 is a perspective view of a ground insert of the outdoor lighting fixture as shown in FIG. 1;

FIG. 3 is a top view of the ground insert as shown in FIG. 2;

FIG. 4 is a perspective view of the ground insert as shown in FIG. 2 seen from another angle;

FIG. 5 is an exploded view of an outdoor lighting fixture provided by the second embodiment of the present invention;

FIG. 6 is a perspective assembly view of a ground insert of the outdoor lighting fixture as shown in FIG. 5;

FIG. 7 is a perspective exploded view of the ground insert as shown in FIG. 6;

FIG. 8 is a bottom view of the ground insert as shown in FIG. 7;

FIG. 9 is an exploded view of an outdoor lighting fixture provided by the third embodiment of the present invention;

FIG. 10 is a perspective assembly view of a ground insert of the outdoor lighting fixture as shown in FIG. 9;

FIG. 11 is a perspective exploded view of the ground insert as shown in FIG. 10;

FIG. 12 is a bottom view of the ground insert as shown in FIG. 11;

FIG. 13 is an exploded view of an outdoor lighting fixture provided by the fourth embodiment of the present invention;

FIG. 14 is a perspective assembly view of a ground insert of the outdoor lighting fixture as shown in FIG. 13;

FIG. 15 is a perspective exploded view of the ground insert as shown in FIG. 14;

FIG. 16 is a perspective exploded view of the ground insert as shown in FIG. 15 seen from another angle; and

FIG. 17 is a bottom view of the ground insert as shown in FIG. 16.

### DETAILED DESCRIPTION OF THE PREFERRED EMBODIMENTS

For more clear understanding of the technical proposals of the present invention, further description will be given below to the present invention with reference to the accompanying drawings.

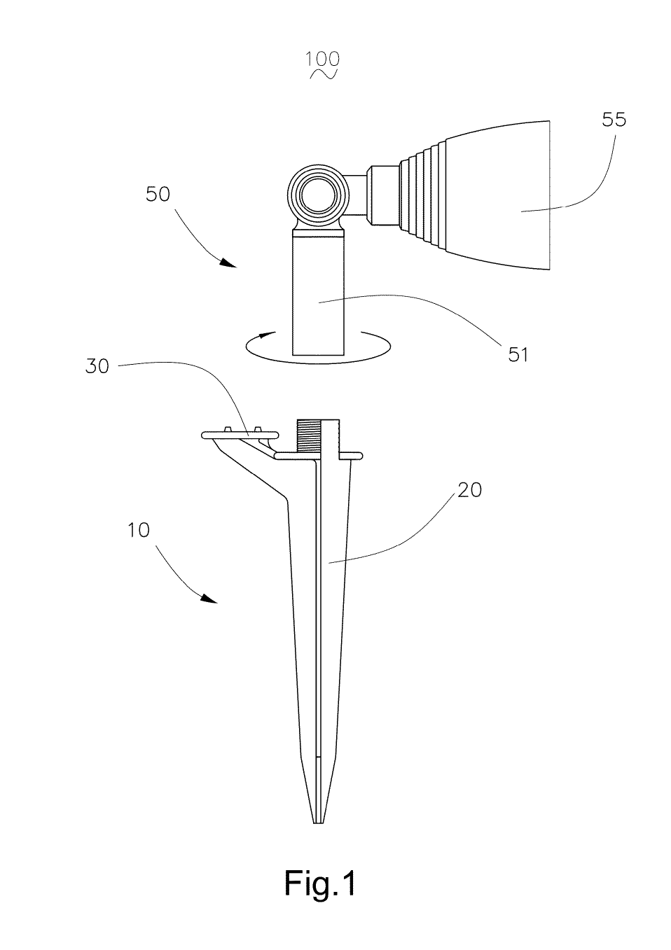

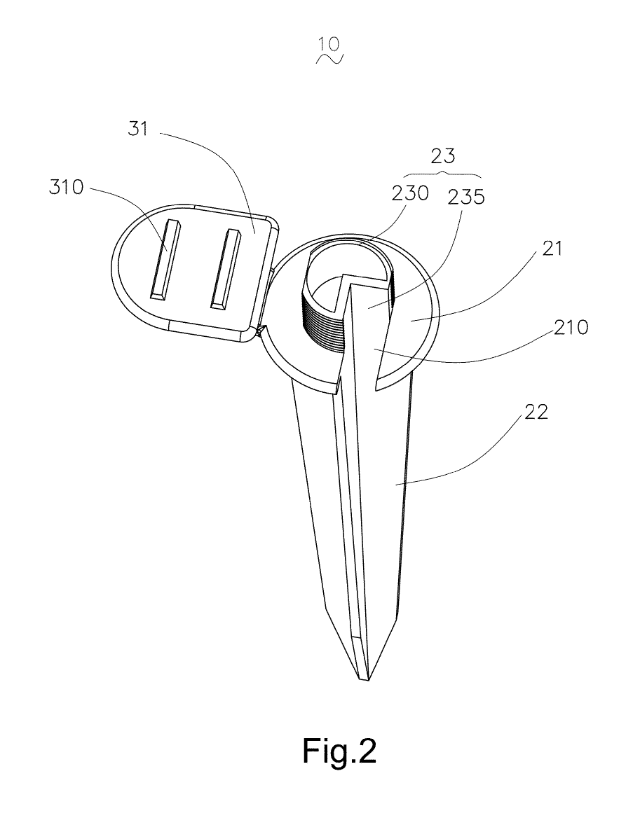

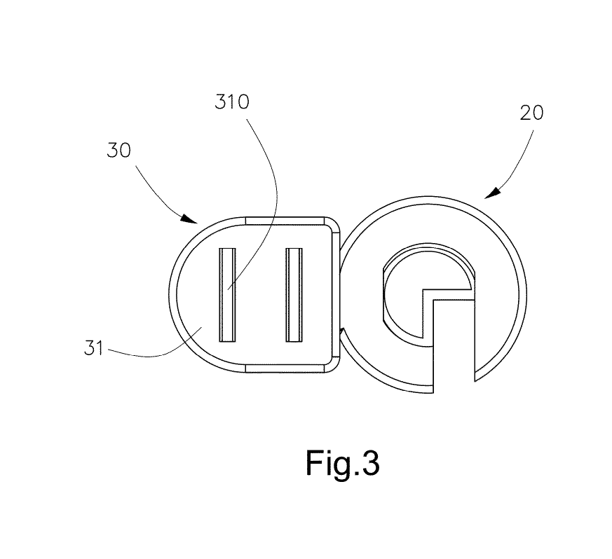

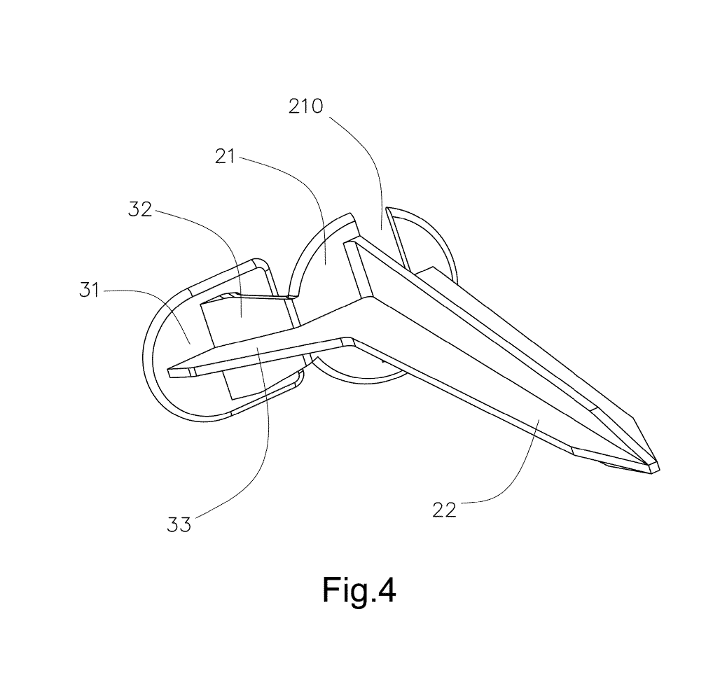

FIGS. 1 to 4 illustrate an outdoor lighting fixture 100 provided by the first embodiment of the present invention. The outdoor lighting fixture 100 includes a ground insert 10 and a lamp body 50 mounted on the top of the ground insert 10. The ground insert 10 includes an embedded member 20 and a tread member 30 connected with the top of the embedded member 20.

In the embodiment, the tread member 30 and the embedded member 20 are integrally formed. More specifically, the tread member 30 and the embedded member 20 are formed by the integral die casting of a mold. The embedded member 20 includes a base 21, a plurality of side plates 22 radially extended downwards and outwards from a bottom surface of the base 21, and a mounting portion 23 extended upwards from a top surface of the base 21. The base 21 is in the shape of a disc, and a rectangular notch 210 is formed in the middle of the base 21. The side plates 22 are extended outwards from a central axis of the embedded member 20. The vertical distance between the outer edge of each side plate 22 and the central axis of the embedded member 20 is gradually increased from the bottom up. Thus, a tapered tip is formed at the bottom of the embedded member 20, so that the embedded member 20 can be inserted into the soil on the ground. In the embodiment, the number of the side plates 22 is four.

The mounting portion 23 includes a circular threaded portion 230 and a side wall 235 connected with a free end of the threaded portion 230. The arc chord angle of the threaded portion 230 is 270°. The cross section of the side wall 235 is L-shaped. The central section of the side wall 235 is disposed in the center of the mounting portion 23. In the embodiment, the side wall 235 vertically corresponds to two adjacent side plates 22 and corresponds to the inner edge of the notch 210.

The tread member 30 includes a platform portion 31, a sloping plate 32 for connecting the platform portion 31 and the base 21 of the embedded member 20, and a riser 33 for connecting the platform portion 31 and the side plate 22 of the embedded member 20. The platform portion 31 is in the shape of a flat plate. A plurality of protrusions 310 are extended on a top surface of the platform portion 31 to increase the friction force. As the platform portion 31 is higher than the base 21, the sloping plate 32 is inclined upwards from the base 21 and extended towards the platform portion 31. It should be understood that in other embodiments, the top surface of the platform portion 31 may be parallel to the top surface of the base 21. The riser 33 and one side plate 22 are aligned in the same plane and integrally connected. The riser 33 is vertically connected with the platform portion 31. The tread member 30 and the notch 210 are respectively connected with two opposite sides of the base 21.

The lamp body 50 includes a screwing portion 51 and a lamp body 55 pivotally connected with the top of the screwing portion 51. A pivot axis of the lamp body 55 and the screwing portion 51 is extended along the horizontal direction, so that the lamp body 55 can turn over at least 180° in a vertical plane around the top of the screwing portion 51. The screwing portion 51 is in the shape of a hollow tube. Threads are formed on an inner wall of the screwing portion 51, so that the screwing portion 51 can be engaged with the threaded portion 230 of the mounting portion 23.

In the case of use, the lamp body 50 is connected to the ground insert 10 and inserted into appropriate ground; the platform portion 31 of the tread member 30 is treaded by feet of a user; the lamp body 50 is held by hands of the user; the hands and the feet apply force at the same time; and hence the entire outdoor lighting fixture 100 is driven to be inserted into the ground, which is convenient and swift.

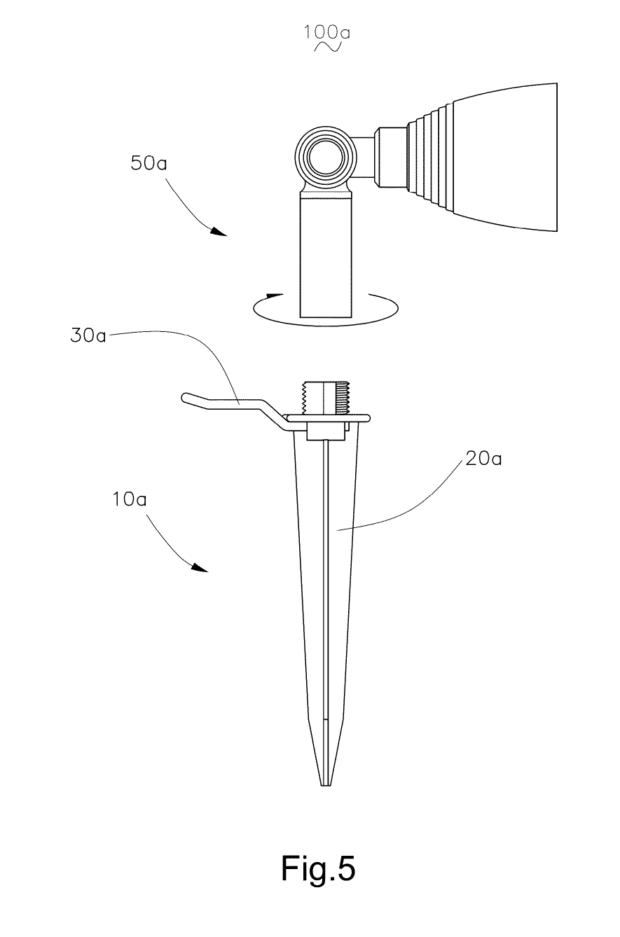

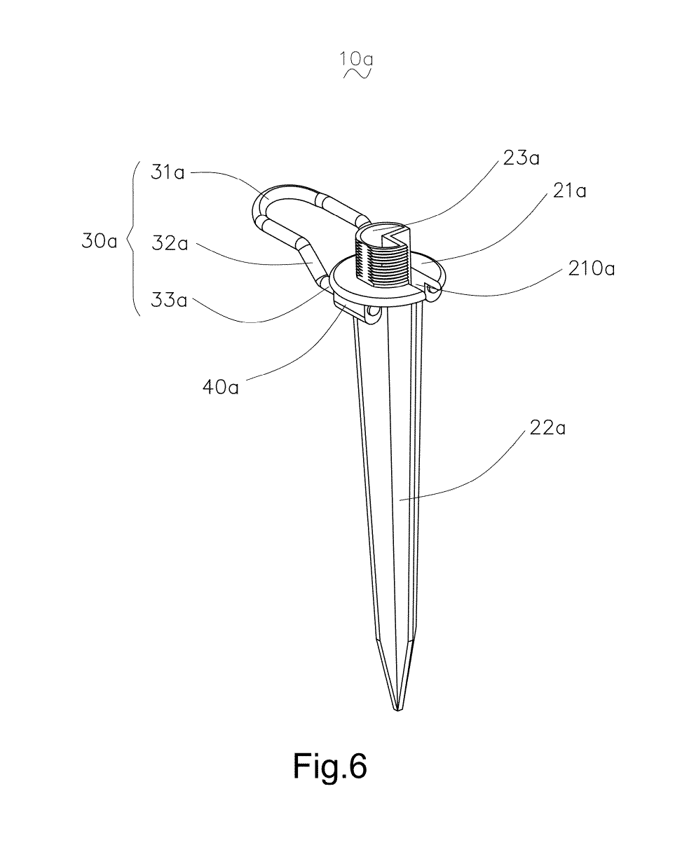

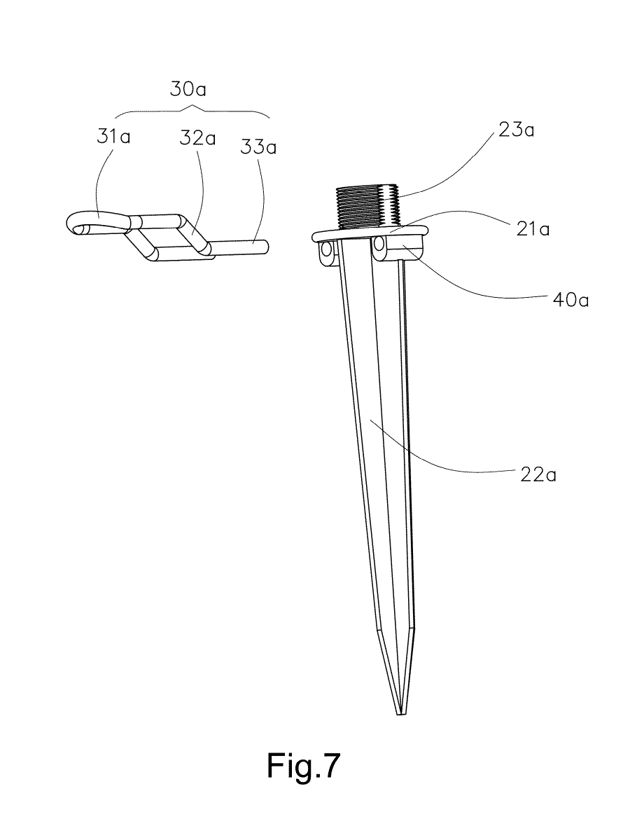

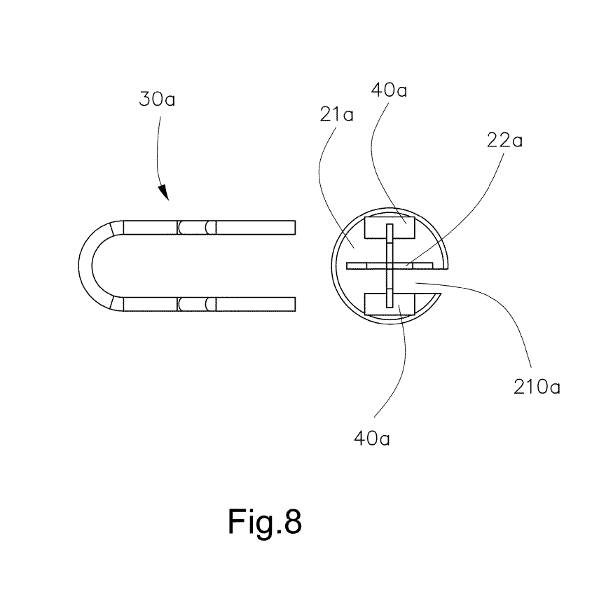

FIGS. 5 to 8 illustrate an outdoor lighting fixture 100a provided by the second embodiment of the present invention. The outdoor lighting fixture 100a includes a ground insert 10a and a lamp body 50a mounted on the top of the ground insert 10a. The ground insert 10a includes an embedded member 20a and a tread member 30a connected with the top of the embedded member 20a. The tread member 30a and the embedded member 20a are separately manufactured. The lamp body 50a is the same with the lamp body 50 in the first embodiment.

The embedded member 20a is similar to the embedded member 20 in the first embodiment and includes a base 21a, a plurality of side plates 22a radially extended downwards and outwards from a bottom surface of the base 21a, and a mounting portion 23a extended upwards from a top surface of the base 21a. The base 21a is provided with a notch 210a. The difference from the embedded member 20 is that two connecting portions 40a are extended downwards from a bottom surface of the base 21a of the embedded member 20a. Each connecting portion 40a is longitudinally and horizontally extended and parallel to the notch 210a. An insertion hole 41a is formed in the middle of each connecting portion 40a. In the embodiment, the insertion holes 41 a are horizontally arranged.

The tread member 30a is formed by the integral bending of a metal rod body and is U-shaped on the whole. The tread member 30a includes a U-shaped body portion 31a, sloping portions 32a respectively connected with two free ends of the body portion 31a, and embedded portions 33a correspondingly connected with free ends of the sloping portions 32a. The central section of the body portion 31a is tip-tilted. The embedded portions 33a are horizontally arranged and correspondingly inserted into the insertion holes 41a of the connecting portions 40a of the embedded member 20a. The body portion 31a is higher than the base 21a. The sloping portion 32a is inclined from the bottom up from the embedded portion 33a to the body portion 31a.

In the case of user, as similar to the outdoor lighting fixture 100 provided by the first embodiment, the lamp body 50a is connected to the ground insert 10a and inserted into appropriate ground; the body portion 31a of the tread member 30a is treaded by feet of a user; the lamp body 50a is held by hands of the user; the hands and the feet apply force at the same time; and hence the outdoor lighting fixture 100a is driven to be inserted into the ground.

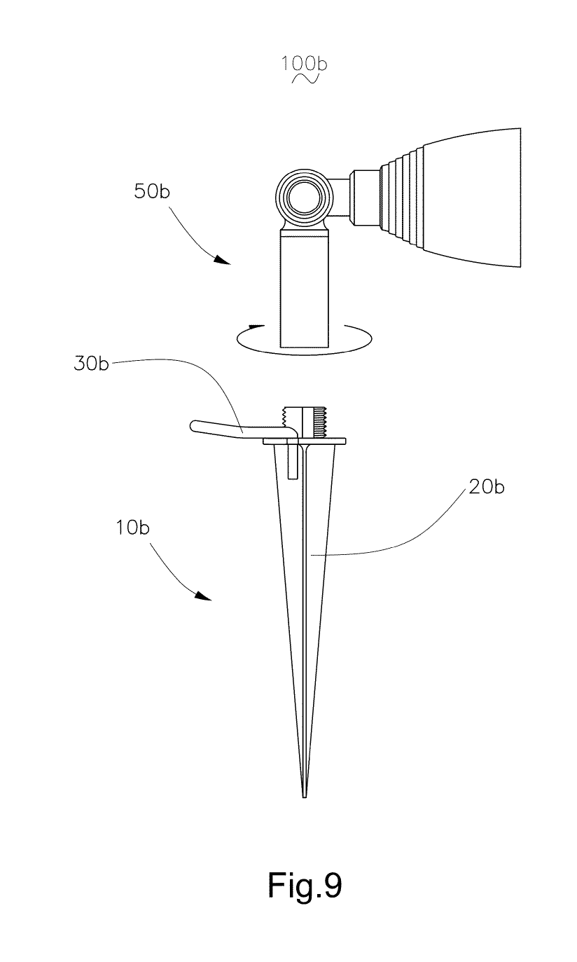

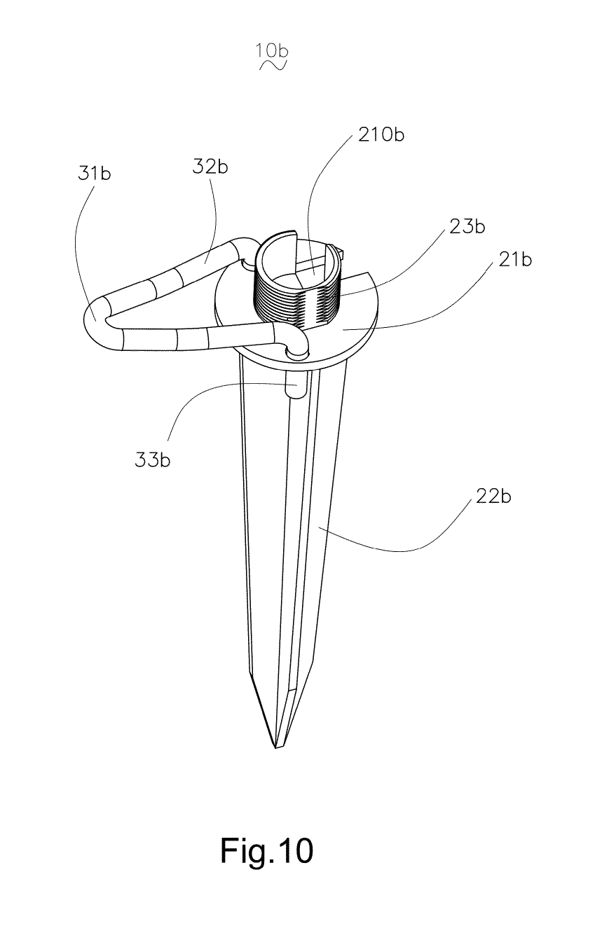

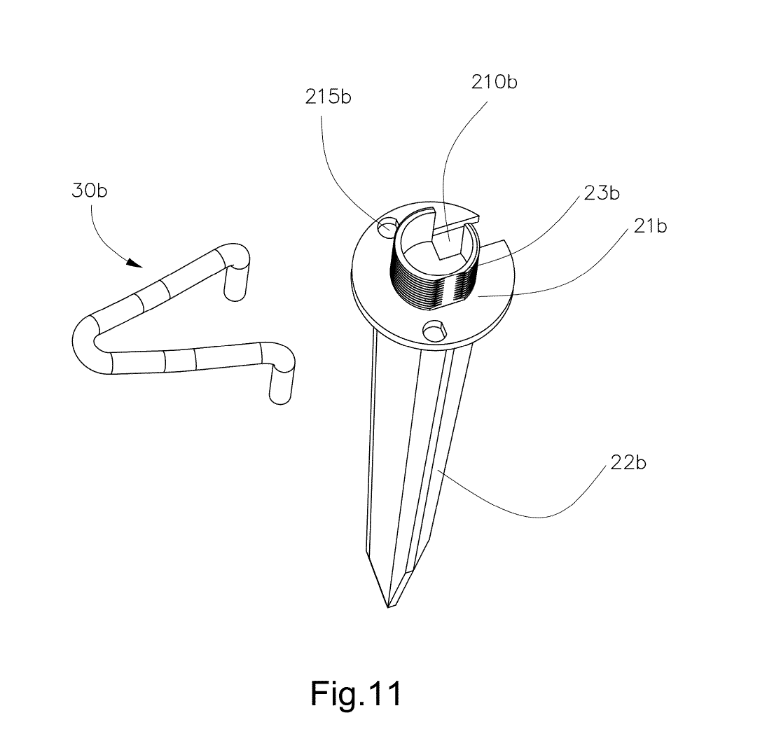

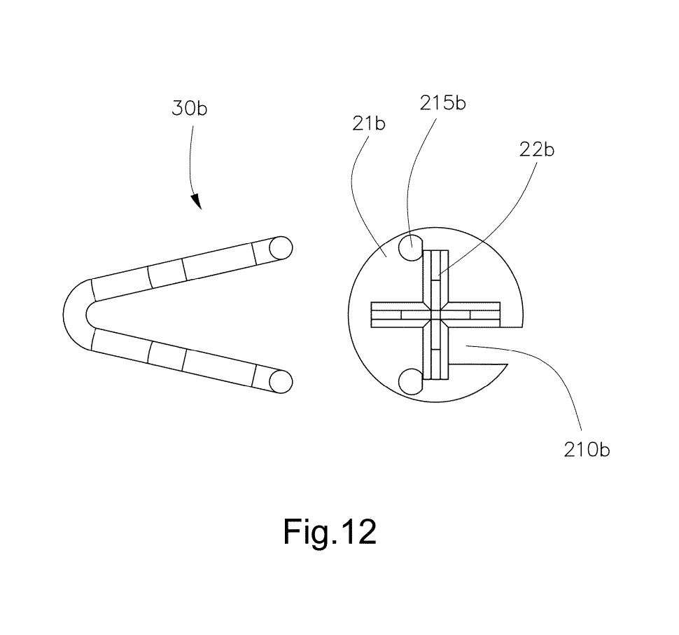

FIGS. 9 to 12 illustrate an outdoor lighting fixture 100b provided by the third embodiment of the present invention. The outdoor lighting fixture 100b includes a ground insert 10b and a lamp body 50b mounted on the top of the ground insert 10b. The ground insert 10b includes an embedded member 20b and a tread member 30b connected with one side of the top of the embedded member 20b. The tread member 30b and the embedded member 20b are separately manufactured. The lamp body 50b is the same with the lamp body 50 in the first embodiment.

The embedded member 20b is similar to the embedded member 20a in the second embodiment and includes a base 21b, a plurality of side plates 22b radially extended downwards and outwards from a bottom surface of the base 21b, and a mounting portion 23b extended upwards from a top surface of the base 21b. The base 21a is provided with a notch 210b. The difference from the outdoor lighting fixture 100a provided by the second embodiment is that insertion holes 215b running through up and down are formed on two opposite sides of the base 21b of the embedded member 20b of the outdoor lighting fixture 100b. The tread member 30b is formed by the integral bending of a metal rod body and is U-shaped on the whole. The tread 30b includes a U-shaped body portion 30b, horizontal portions 32b respectively connected with two free ends of the body portion 31b, and embedded portions 33b correspondingly connected with free ends of the horizontal portions 32b. Each embedded portion 33b is arranged vertically downwards and perpendicular to corresponding horizontal portion 32b. In the case of assembly, the embedded portions 33b are inserted into the insertion holes 215b of the base 21b, and the horizontal portions 32b press the top surface of the base 21b.

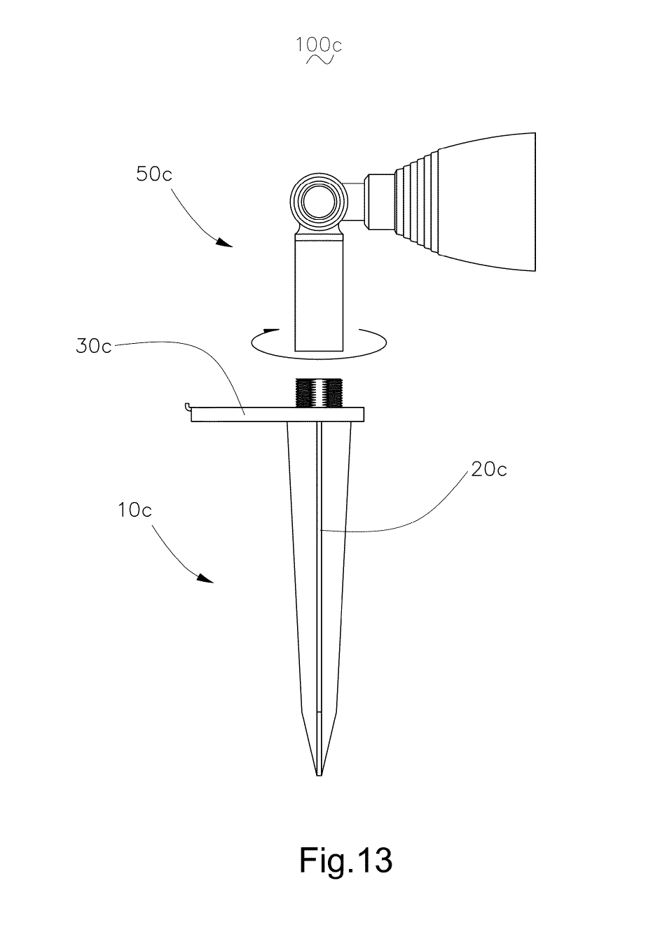

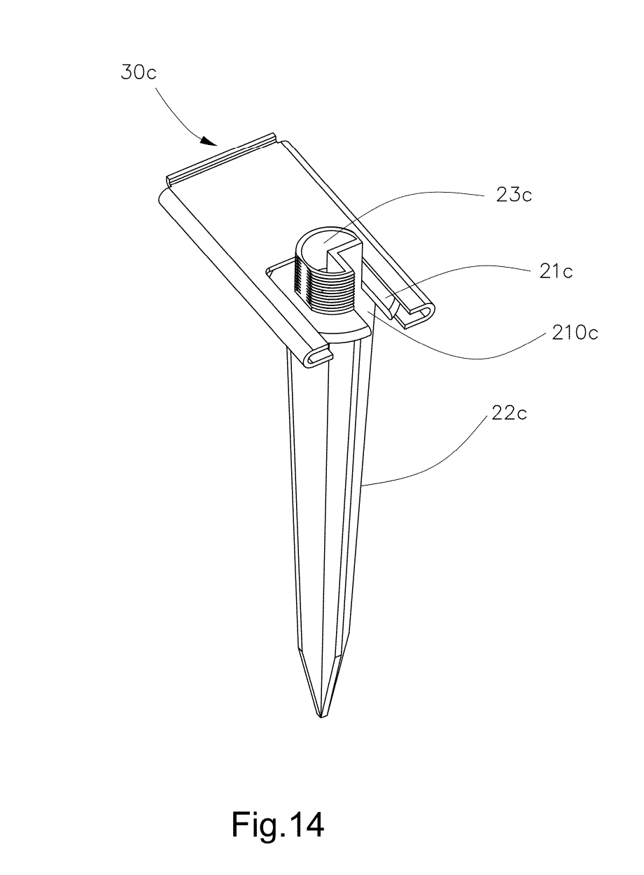

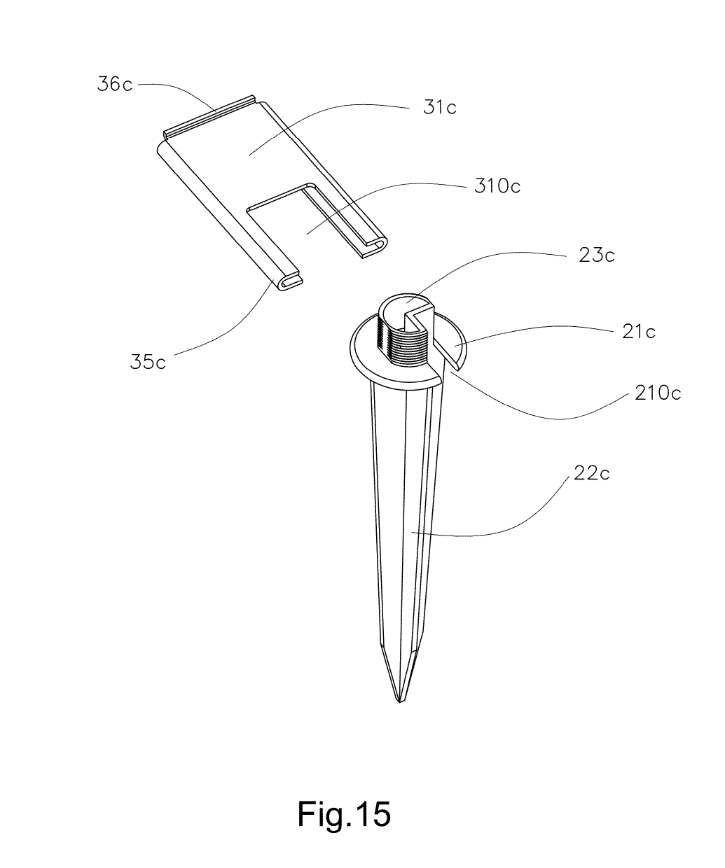

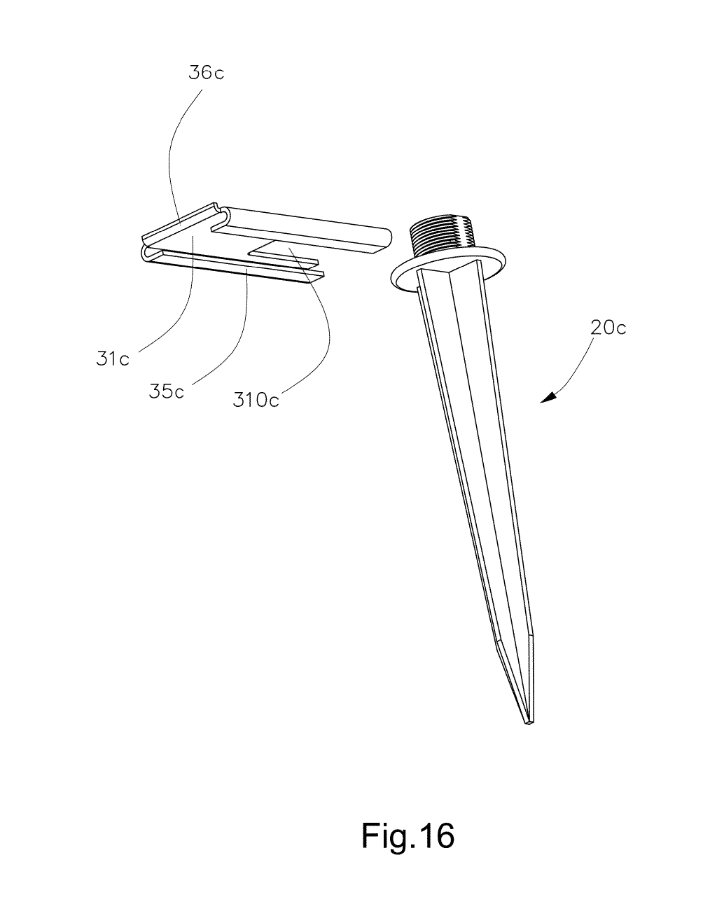

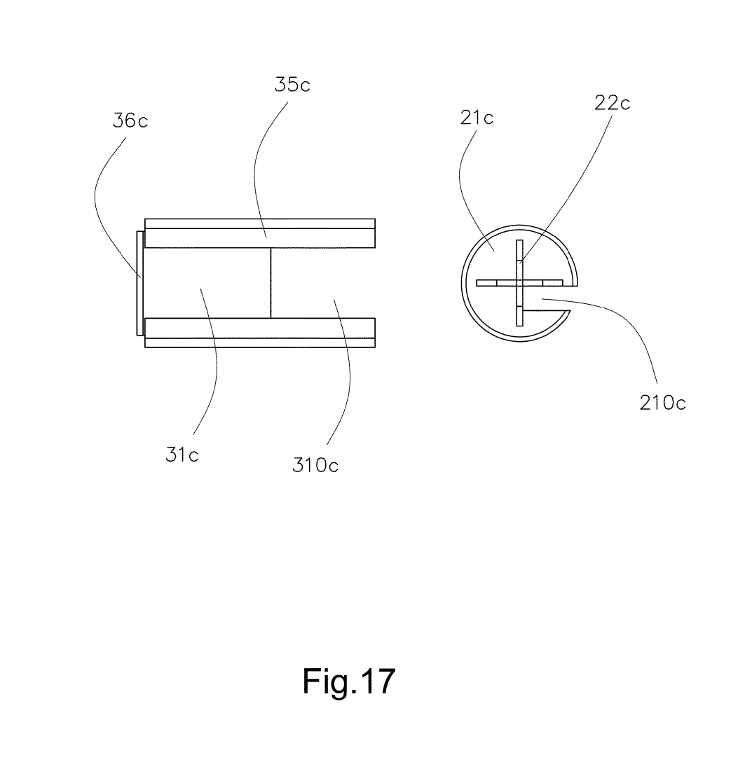

FIGS. 13 to 17 illustrate an outdoor lighting fixture 100c provided by the fourth embodiment of the present invention. The outdoor lighting fixture 100c includes a ground insert 10c and a lamp body 50c mounted on the top of the ground insert 10c. The ground insert 10c includes an embedded member 20c and a tread member 30c connected with one side of the top of the embedded member 20c. The tread member 30c and the embedded member 20c are separately manufactured. The lamp body 50c is the same with the lamp body 50 in the first embodiment. The embedded member 20c is similar to the embedded member 20 in the first embodiment and includes a base 21c, a plurality of side plates 22c radially extended downwards and outwards from a bottom surface of the base 21c, and a mounting portion 23c extended upwards from a top surface of the base 21c. The base 21c is provided with a notch 210c.

The tread member 30c is in the shape of a flat plate and includes a platform portion 31c and limiting portions 35c bent downwards at first and hence bent inwards from two opposite sides of the platform portion 31c. The platform portion 31c and the limiting portions 35c on both sides are encircled into a flat accommodating space. A clamping groove 310c is formed in the central section of one end of the platform portion 31c facing the embedded member 20c. The width of the clamping groove 310c is greater than the horizontal width of the mounting portion 23c of the embedded member 20c. A tip-tilted portion 36c is extended upwards at one end of the platform portion 31c away from the clamping groove 310c, so that the feet of the user will not skid off the platform portion 31c in the case of tread.

In the case of assembly, the base 21c of the embedded member 20c is embedded into the accommodating space of the embedded member 30c. A peripheral portion of the base 21c abuts against the bottom surface of the platform portion 31c and the inside of the limiting portion 35c, so that the tread member 30c and the embedded member 20c can be tightly combined. In the case of use, the lamp body 50c is connected to the ground insert 10c and inserted into appropriate ground; the tread member 30c is treaded by feet of a user; the lamp body 50c is held by hands of the user; the hands and the feet apply force at the same time; and hence the outdoor lighting fixture 100c is driven to be inserted into the ground.

The above embodiments only illustrate multiple implementations of the present invention, are described in detail, but should not be construed as the limitation of the scope of the patent of the present invention. It should be noted that a plurality of variations and modifications may also be made by those skilled in the art without departing from the concept of the present invention and shall all fall within the scope of protection of the present invention. Therefore, the scope of protection of the patent of the present invention shall be defined by the appended claims.

What is claimed is:

1. An outdoor lighting fixture, comprising a ground insert and a lamp body mounted on the ground insert, wherein the ground insert includes an embedded member and a tread member connected with the top of the embedded member; the embedded member includes a base, a plurality of side plates radially extended downwards and outwards from a bottom surface of the base, and a mounting portion extended upwards from a top surface of the base; the lamp body is mounted on the mounting portion; and the tread member is connected with the base.

2. The outdoor lighting fixture according to claim 1, wherein the tread member and the embedded member are integrally formed; the tread member includes a platform portion, a sloping plate for connecting the platform portion and the base of the embedded member, and a riser for connecting the platform portion and the side plate of the embedded member.

3. The outdoor lighting fixture according to claim 2, wherein as the platform portion is higher than the base, the sloping plate is inclined upwards from the base and extended towards the platform portion; and the riser and one side plate are aligned in the same plane and integrally connected.

4. The outdoor lighting fixture according to claim 1, wherein the tread member and the embedded member are separately manufactured; the tread member is formed by the integral bending of a metal rod body; at least two insertion holes are formed on the base of the embedded member; and the tread member is partially embedded into the insertion holes so as to be connected with the embedded member.

5. The outdoor lighting fixture according to claim 4, wherein the base includes two connecting portions; the insertion holes are transversely formed in corresponding connecting portions; the tread member includes a U-shaped body portion, sloping portions respectively connected with two free ends of the body portion, and embedded portions correspondingly connected with free ends of the sloping portions; and the embedded portions are correspondingly inserted into the insertion holes of the connecting portions.

6. The outdoor lighting fixture according to claim 4, wherein the insertion holes are formed on the base by running through up and down; the tread member includes a U-shaped body portion, horizontal portions respectively connected with two free ends of the body portion, and embedded portions correspondingly connected with free ends of the horizontal portions; and the embedded portions are correspondingly vertically inserted into the insertion holes of the connecting portions.

7. The outdoor lighting fixture according to claim 1, wherein the tread member and the embedded member are separately manufactured; the tread member is in the shape of a flat plate and includes a platform portion and limiting portions bent downwards at first and hence bent inwards from two opposite sides of the platform portion; and the platform portion and the limiting portions on both sides are encircled into a flat accommodating space to accommodate the base of the embedded member.

8. A ground insert configured to fix a lamp body of an outdoor lamp, wherein the ground insert includes an embedded member and a tread member connected with the top of the embedded member; the embedded member includes a base, a plurality of side plates extended from a bottom surface of the base, and a mounting portion extended upwards from a top surface of the base; the tread member and the embedded member are integrally formed; the tread member includes a platform portion, a sloping plate for connecting the platform portion and the base of the embedded member, and a riser for connecting the platform portion and the side plate of the embedded member; and the riser and one side plate are aligned in the same plane and integrally connected.

9. The ground insert according to claim 8, wherein as the platform portion is higher than the base, the sloping plate is inclined upwards from the base and extended towards the platform portion.

10. A ground insert configured to fix a lamp body of an outdoor lamp, wherein the ground insert includes an embedded member and a tread member connected with the top of the embedded member; the embedded member includes a base, a plurality of side plates extended from a bottom surface of the base, and a mounting portion extended upwards from a top surface of the base; the tread member and the embedded member are separately manufactured; the tread member is formed by the integral bending of a metal rod body; at least two insertion holes are formed on the base of the embedded member; and the tread member is partially embedded into the insertion holes so as to be connected with the embedded member.

11. The ground insert according to claim 10, wherein the base includes two connecting portions; the insertion holes are transversely formed in corresponding connecting portions; the tread member includes a U-shaped body portion, sloping portions respectively connected with two free ends of the body portion, and embedded portions correspondingly connected with free ends of the sloping portions; and the embedded portions are correspondingly inserted into the insertion holes of the connecting portions.

12. The ground insert according to claim 10, wherein the insertion holes are formed on the base by running through up and down; the tread member includes a U-shaped body portion, horizontal portions respectively connected with two free ends of the body portion, and embedded portions correspondingly connected with free ends of the horizontal portions; and the embedded portions are correspondingly vertically inserted into the insertion holes of the connecting portions.
